(19) United States
(12) Patent Application Publication
(10) Pub. No.: US 2014/0217822 A1
(43) Pub. Date: Aug. 7, 2014

(54) External Control of Power by Using Powered Device Specifications

(71) Applicant: Carl Lee Danner, Bakersfield, CA (US)

(72) Inventor: Carl Lee Danner, Bakersfield, CA (US)

(21) Appl. No.: 13/760,029

(22) Filed: Feb. 5, 2013

(51) Int. Cl. H02J 4/00

(52) U.S. Cl. CPC H02J 4/00
USPC 307/31

(57) ABSTRACT

A powered device has a specifications storage device. Specifications are sent to an interpreter that converts specifications into power supply control signals. The specifications storage device and powered device can be removed. They are replaced with a new powered device and a specification storage device that contains specifications of the new powered device.

### REFERENCES CITED

U.S. Patent Applications

| | | |
|---|---|---|
| 13/088,429 | April 2011 | Danner |
| 13/350,950 | January 2012 | Danner |
| 13/712,967 | December 2012 | Danner |

### FIELD OF THE INVENTION

This invention relates to externally controllable power supplies.

### BACKGROUND OF THE INVENTION

Externally controllable power sources can be controlled by a signal that is generated by a unit that is located with a powered device. Locating the signal generating unit with the powered device allows easy access to sensor information from the powered device. Specifications of the powered device may also be used to by the externally controllable power source. This specifications information, sensor information, and other information such as information the externally controllable power source may have about how various sensor and specifications interact with each other to affect power needs of a powered device permits the externally controllable power source to determine many things about the power requirements of the powered device. This allows the externally controllable power source to deliver power that is specific to the needs of the powered device.

There are currently three main types of externally controllable power sources based on control methods.

A first type of prior art externally controllable power source has no signal processing in the externally controllable source other than circuits associated with any internal source that allow the internal source to be controlled. The externally controllable source does not make decisions about power output. The control signals for the internal source of the externally controllable power supply are developed by a controller that is associated with the powered device. This control method requires that the controller must know something about the internal operation of the power source in order to control it. The externally controllable source is rather simple because there is no decision making unit that determines how to control the controllable source so as to deliver an appropriate power.

A second prior art externally controllable power source uses a power request signal from an external power request generator. The power request generator may use sensor information and specifications of the powered device to develop a power request. The power request specifies the value of a power parameter that the externally controllable source is to provide. The externally controllable power source is expected to provide power having the level of power requested at all times. Having a requested level of power at all times is important for some equipment. Requiring a specific level of power at all times results in more complex power request methods than are needed by some equipment such as batteries.

A third type prior art externally controllable power source responds to power directions. The two most important directions are “increase power” and “decrease power”. Additional directions such as “hold present power level” or “increase rate of change of power” or “decrease rate of change of power” may be needed in some cases. The director does not need to develop different control signals for different power sources such as is the case in the first method. Using directions is simpler than using the power request of the second method because directions do not specify a power level. It might seem that a source controller that responds to directions can be simple because there may only be two or three directions that are given, however a source controller that responds to directions needs to be more intelligent than a source controller responding to power requests because it must make decisions about power output based on less information. A source controller that is responding to an “increase power” direction has no way of knowing how much power the powered device needs. It only knows that the powered device needs more power than it is presently receiving. The source controller must be careful not to over-power the powered device. The source controller will start delivering power at a low level. It will then increase power until it receives a “decrease power” or a “hold present level” signal. The source controller of the present invention may not deliver as much power as the powered device needs in order to prevent damage to the powered device due to receiving too little power as it ramps up to an appropriate power level. The present invention may not be suitable for delivering power to some motors or other equipment that could be damaged by receiving too little power.

All three of the previous methods require equipment associated with a powered device to send some sort of control signal to an externally controllable power source. It is therefore an object of the present invention to provide an external control method that has does not require equipment associated with a powered device to develop control signals.

It is a further object of the present invention to provide a power control method that is less complex than using a power request or power direction.

### SUMMARY OF THE INVENTION

In accordance with these and other objects of the invention there are provided methods of controlling an externally controllable power source without using any power control signals. Instead only information about the powered device will be sent.

A first type of information controlled externally controllable power supply uses only specifications of the powered device. For example only one specification may be sent. That specification may be the recommended charging voltage.

A second type type of information controlled externally controllable power supply uses powered device specifications and powered device sensor information.

A third type type of information controlled externally controllable power supply uses powered device specifications, present powered device sensor information, and historical sensor information. Historical sensor information may be information such as how many times a powered device has been charged if the powered device is a battery.

In all embodiments the externally controllable power source has an analyzer that receives information about the powered device rather than receiving control signals. The analyzer uses the information to develop signals to control a controllable power source. The controllable power source delivers power to a powered device. The powered device has associated units that develop and deliver information about the powered device to the analyzer. The differences between embodiments of the invention are differences in the ability of the analyzer to develop power control signals using different types of information.

In a first embodiment the analyzer uses only specifications information about the powered device.

In a second embodiment the analyzer uses specifications information and real time sensor information about the powered device.

In a third embodiment the analyzer uses specifications information, real time sensor information, and history related sensor information.

There are other types of information that analyzers could use. For example, powered device specifications may only specify the type chemical that a battery uses. The analyzer may use information that is permanently stored in the analyzer about various battery chemicals. These various other information sources are not described in this document as they are obvious expansions on the basic idea of using information about the powered device to develop power source control signals as opposed to responding to control signals.

### BRIEF DESCRIPTION OF THE DRAWINGS

The foregoing and other objects and features of the present invention can be more readily understood with reference to the following description, taken in conjunction with accompanying drawings. Like reference numerals designate like electrical elements. Dotted lines represent status signal lines, power control signals, sensor information, or controllable source signals. Solid lines represent power conductors.

FIG. 1 shows an aspect of the present invention. An analyzer receives powered device specifications from a memory device. The analyzer will use specifications of the powered device to develop a source control signal. Power flow will flow from the controllable source to the powered device. The analyzer has no way to monitor power flow to the powered device so the analyzer has no way to know the status of the power supply. Power delivery may only stop based on analyzer knowledge of powered device capacity. Power delivery will more likely stop when the powered device is unplugged from the power supply. This simple control method may be suitable for powered devices that will not be damaged by prolonged power delivery.

FIG. 2 is similar to FIG. 1. It shows the same externally controllable power source as that of FIG. 1. Now new specifications are being delivered to the externally controllable power supply. A new power level is being delivered to a new powered device.

FIG. 3 shows an aspect of the present invention that allows the analyzer to know more about the status of power delivery such as the voltage and current flow into the powered device. The powered device may be the same as the powered device of FIG. 1. Only equipment that delivers specifications of the powered device is needed. This power control method may be suitable for powered devices when sensor data is not important to the delivery of acceptable power.

FIG. 4 shows another aspect of the present invention. An analyzer receives powered device specifications from a memory device and information from sensors that monitor the powered device. Sensors at the powered device allow the analyzer know more about the status of the powered device than is possible using only sensors on the power line feeding the device.

FIG. 5 shows another aspect of the present invention. Sensor information at the powered device can be stored in a device located with the powered device. New information such as the number of times a battery has been charged can be determined. The charging history of a powered device such as a battery can help the analyzer to deliver appropriate power.

### DETAILED DESCRIPTION OF THE INVENTION

It should be understood that although the invention is described with reference to providing power to a powered device, direct current electrical power may be supplied to an energy storage device such as a battery. It is contemplated that the principles of the invention may be employed to provide power to other types of equipment or to providing other types of power such as alternating current with multiple phases or hydro or gas pressure power. Use of the present invention with large mining equipment or other powered machinery may allow for more efficient control of power. Electrical power is used in this document because it is a common type of power.

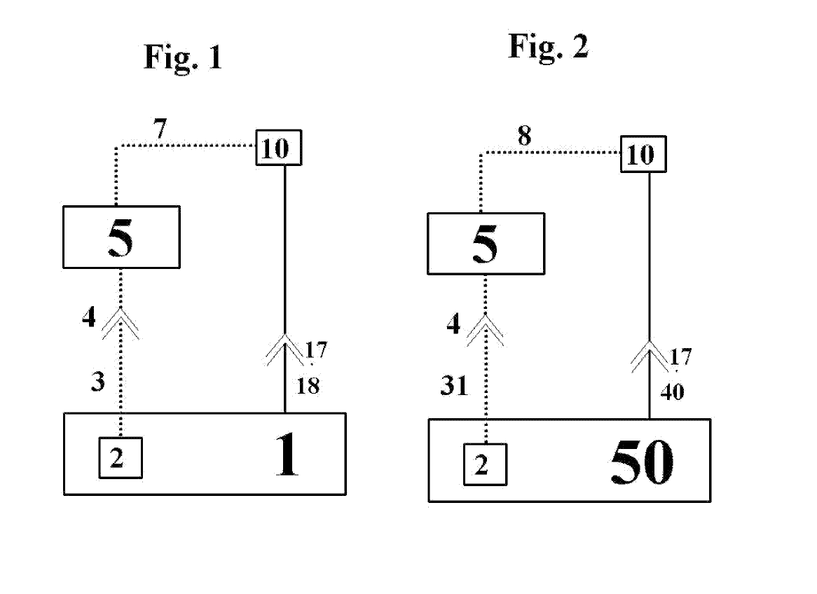

Referring now to FIG. 1 of the drawings, a block diagram shows powered device 1 specifications 3 from memory device 2 being delivered to analyzer 5 via connector 4. Analyzer 5 uses specifications 3 to make control signal 7 which is used by controllable source 10 to deliver power 18 to powered device 1 via connector 17.

Referring now to FIG. 2 of the drawings, a block diagram shows the same externally controllable power source as was shown in FIG. 1. Now a new powered device 50 is receiving a new power 40 via connector 17. Powered device 50 may have an identical specifications memory device 2 as powered device 1 however specifications 31 are different because they are for powered device 50. Analyzer 5 now develops a control signal 8 having a different control level. Signal 8 controls controllable source 10 to deliver a new power 40 to powered device 50 via connector 17. Powered devices in all figures are removable and replaceable with different powered devices that need different power.

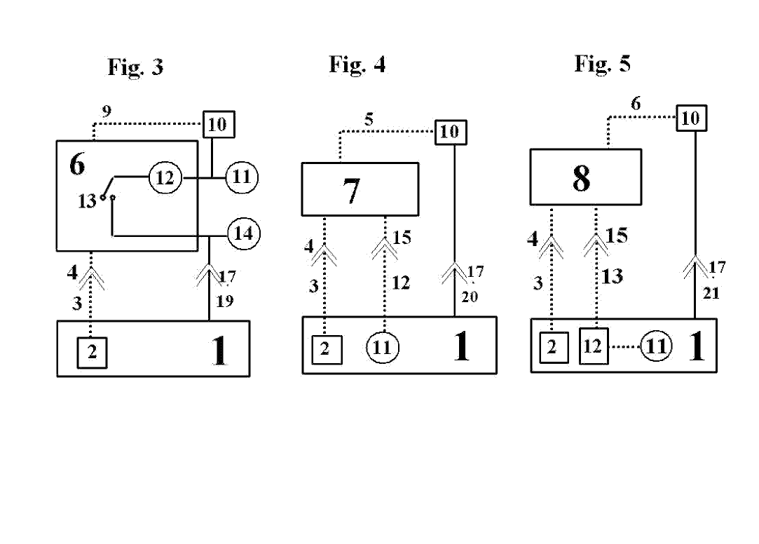

Referring now to FIG. 3 of the drawings, a block diagram shows the same powered device 1 with the same memory device 2 delivering the same specifications 3 as was shown in FIG. 1. Now a new analyzer 6 uses specifications 3. The new analyzer 6 has ability to monitor voltage at source 10 using meter 11 and and voltage at powered device 1 via connector 17 using meter 14. If switch 13 is open then voltage at powered device 1 may be monitored unaffected by source 10. When switch 13 is closed current flow from source 10 may be measured using ammeter 12. Analyzer 6 is different from analyzer 5 of FIG. 1 or FIG. 2 because it is able to use this new voltage and current information to monitor charging power. This enables analyzer 6 to make better decisions as to what power 19 to deliver to powered device 1 via connector 17. Power control signal 9 has a different level than the power control signal in FIG. 1

Referring now to FIG. 4 of the drawings, a block diagram shows the same powered device 1 with the same memory device 2 delivering the same specifications 3 as was shown in FIG. 1. Powered device 1 now has sensors that monitor various things such as temperature of powered device 1, current flowing into powered device 1 via connector 17, and voltage at the connection to powered device 1. Other things may that affect the status of powered device 1 could be monitored such as electrolyte level or revolutions per minute if powered device 1 is a motor or engine. Sensor information 12 from various sensors 11 will be used by analyzer 7 to make a different power control signal 5 than was made in FIG. 1 or FIG. 3. A new power 20 is now delivered to powered device 1 via connector 17.

Referring now to FIG. 5 of the drawings, a block diagram shows the same powered device 1 with the same memory device 2 delivering the same specifications 3 to analyzer 8. Analyzer 8 has the abilities of analyzer 7 in FIG. 4. Analyzer 8 also has the ability to use sensor history information 13 stored in memory device 12 that may have been developed using the same sensors 11 as were used in FIG. 4. This new information allows analyzer 8 to create a new power control signal 6 to control controllable power source 10 so as to deliver a new power 21 to powered device 1 via connector 17.

Thus there have been shown and described power supply configurations that do not require a powered device to send control signals and that allow externally controllable power sources to use information about powered devices or power storage devices such as batteries so as to deliver acceptable power. It is to be understood that the above-described embodiments of the invention are merely illustrative of many possible embodiments, which represent applications of the principle of the present invention. An internal source may be able to provide many types of electrical power such as hydraulic, compressed air, electric direct current, pulsed direct current, alternating current in various power configurations such as one phase, two phase, three phase, WYE, delta etc. It therefore should be obvious that these or other parameters may be delivered by an externally controllable power source without deviating from the spirit of the present invention. Numerous varied other arrangements can be readily devised in accordance with these principles by those skilled in the art without departing from the spirit and scope of the invention.

What is claimed is:

1. An externally controllable power source comprising:
means to receive first powered device specifications;
means for an analyzer to use said first powered device specifications to develop power control signals;
means to deliver said power control signals to a controllable power source;
means to transfer power from said controllable power source to said first powered device;
means to replace said first powered device with a second powered device;
means for said analyzer to use specifications of said second powered device to develop power control signals;
means to deliver said power control signals to said controllable power source;
means to transfer power from said controllable power source to said second powered device;

2. The externally controllable power source of claim 1. comprising:
means to receive powered device sensor information;
means for said analyzer to use said powered device sensor information to develop power control signals;

3. The externally controllable power source of claim 2. comprising:
means to receive powered device history related sensor information;
means for said analyzer to use said powered device history related sensor information to develop power control signals;
